(19) United States
(12) Patent Application Publication
(10) Pub. No.: US 2020/0385285 A1
(43) Pub. Date: Dec. 10, 2020

(54) SENSOR SYSTEM FOR A SYSTEM ALLOWING FOR PURIFICATION AND RECYCLING OF WATER OR SEPARATION OF WATER

(71) Applicant: ORBITAL SYSTEMS AB, MALMÖ (SE)

(72) Inventors: Joakim OSCARSON, VEJBYSTRAND (SE); Michael RIDELL, STAFFANSTORP (SE); Mikael NILSSON, TRELLEBORG (SE)

(21) Appl. No.: 16/462,866

(22) PCT Filed: Nov. 22, 2017
(86) PCT No.: PCT/SE2017/051158

§ 371 Date: May 21, 2019

(30) Foreign Application Priority Data
Nov. 25, 2016 (SE) 1651552-0

(51) Int. Cl. C02F 1/00; C02F 1/32; E03B 1/04

(52) U.S. Cl. CPC C02F 1/008; C02F 1/325; C02F 1/001; E03B 2001/045; C02F 2209/11; C02F 2209/05; C02F 2209/42; E03B 1/042

(57) ABSTRACT

The present invention describes a sensor system intended for a system (10) allowing for purification and recycling of IN water or separation of water, wherein said system (10) allowing for purification and recycling of water or separation of water comprises a water treatment unit (40), wherein said sensor system comprises one first sensor type 1 directed to indicating the function of a water treating source in the water treatment unit, and wherein the sensor system also comprises a second sensor type 2 directed to indicating the water quality, and wherein both the first sensor type 1 and the second sensor type 2 give input to a control system (4) of the system (10) with respect to a selection decision of either recycling of water in the system (10) or separation of water from the system (10).

### FIELD OF THE INVENTION

The present invention relates to a sensor system for a system allowing for purification and recycling of water or separation of water.

### TECHNICAL BACKGROUND

There are existing systems allowing for purification and recycling of water or separation of water. One is disclosed in WO 2013/095278 which describes a hybrid device for a recirculation shower, allowing purification and either recycling of water or discarding of water, which hybrid device comprises a recirculation loop and a filter system with a pre-filter and a nano-filter. The sensor system used comprises at least one filter quality sensor and a water quality sensor. Furthermore, in WO2015/094107 there is disclosed a hybrid device allowing purification and either recycling of water or discarding of water, said hybrid device comprising a recirculation loop, a filter system and multiple conductivity sensors. Yet another system is disclosed in NL1039131 which describes a device and method for measuring the water quality of shower water. The sensor system comprises at least one sensor from the group of UV sensors or conductivity sensors.

One aim of the present invention is to provide a sensor system for a system allowing for purification and recycling of water or separation of water, which sensor system provides the basis to optimise the selection decision made when the system either goes into recirculation or separation mode.

### SUMMARY OF THE INVENTION

The stated purpose above is achieved by a sensor system intended for a system allowing for purification and recycling of water or separation of water, wherein said system allowing for purification and recycling of water or separation of water comprises a water treatment unit, wherein said sensor system comprises one first sensor type directed to indicating the function of a water treating source in the water treatment unit, and wherein the sensor system also comprises a second sensor type directed to indicating the water quality, and wherein both the first sensor type and the second sensor type give input to a control system of the system allowing for purification and recycling of water or separation of water comprises a water treatment unit with respect to a selection decision of either recycling of water in the system or separation of water from the system.

The expression “give input to a control system” implies giving a value of the parameter(s) detected by a specific sensor type according to the present invention. The present invention is directed to providing a sensor system which renders a platform for an optimal control of the selection decision of either recycling of water or separation of water in the system, said system e.g. being a shower, a washing machine, dishwasher or the like. The control system may be of any type available on the market today, e.g. such including a microprocessor.

As stated above, the second sensor type is directed to indicating the water quality. This is performed by using a parameter which may be translated into a water quality measure. One example thereof disclosed below is conductivity, but also others are totally possible. Moreover, the first sensor type is directed to indicating the function of a water treating source in the water treatment unit, which according to the present invention implies that the sensor indicates if the water treatment unit functions as intended and/or if the treatment is strong enough to deliver an intended water quality at this stage.

As hinted above, the first sensor type then also gives an input, i.e. “value”, to the control system with reference to the water quality in that sensor measuring point which in turn affects the decision made in the control system with reference to the selection step if water should be recirculated, where the water quality is above the set lowest level, or if water should be separated off, i.e. when the water quality is too low. As noted in the examples shown in FIGS. 1 and 2, this selection can suitably be performed in the drain of the system allowing for purification and recycling of water or separation of water.

### BRIEF DESCRIPTION OF THE DRAWINGS

In FIG. 1 there is shown a system allowing for purification and recycling of water or separation of water where said system comprises a sensor system according to one embodiment of the present invention.

FIG. 2 shows another system intended for allowing for purification and recycling of water or separation of water, said system also comprising a sensor system according to one specific embodiment of the present invention.

### SPECIFIC EMBODIMENTS OF THE INVENTION

Below specific embodiments of the present invention are discussed.

According to one specific embodiment of the present invention, the water treating source is a light unit and the first sensor type is a light sensor. In this case, different form of light is the treating medium. The light unit may be a LED unit, UV-LED unit or a conventional UV unit. Furthermore, the wavelength and colour of the light should be set to optimise for the treatment of water to purify it from contaminants.

According to one specific embodiment, the light unit is a UV unit, e.g. a UV lamp, and then the first sensor type is a UV sensor. Furthermore, the treatment unit may be a combined water heater and water treatment device where the sensor is a UV sensor which at least gives an indication of the function of the UV treatment. If the light reaches the UV sensor, this is an indication that light penetrates the water flow space contained inside the water treatment unit. In the case of a UV lamp, then preferably this is surrounded by a transparent protective cover, e.g. made of a plastic or glass material, such as a quartz glass, to make sure not to contaminate the UV lamp. The space between the quartz glass and the inside wall of the single container holds the water to be treated.

The UV light is intended to penetrate all of that space as effectively as possible. Therefore, it is important to make sure that the UV lamp and also the quartz glass is free from contaminants and fouling. Therefore, to enable cleaning of the transparent protective cover is of importance in relation to the present invention. Therefore, according to one specific embodiment of the present invention, the light unit is a UV lamp being surrounded by a transparent protective cover and wherein both the UV lamp and the transparent protective cover are removable from the bottom of the single container.

In addition to giving an indication of the light penetrating the water space, the first sensor type may also give other pieces of information, parameters or responses. One such is turbidity, which in turn can be used as a parameter on the water quality in that measuring point.

Also other types of sensors are possible to use as complements. Examples are turbidity sensors (or combined UV/turbidity sensors), IR sensors or FTIR (Fourier Transform Infrared Spectroscopy) sensors.

Moreover, also the water treatment unit may be of a different type than a light treatment unit.

According to yet another specific embodiment of the present invention, the second sensor type is a conductivity sensor. One suitable example is an EC (electrical conductivity) sensor.

As mentioned above, the second sensor type functions as a selection sensor, i.e. a sensor giving a value on a parameter to the control system where said parameter has a limit value below which water is separated off and not recirculated. According to the present invention, the first sensor type complements the second sensor type in this operation. This implies that also the first sensor provides a value on a parameter to the control system which affects the selection decision made by the control system.

Furthermore, it should also be noted that this feature implies that there is a contribution also from the first sensor type to the entire control system and algorithm(s) and it is improved over time with reference to the selection decision. Thus, a “learning” sensor system or control system is provided by the present invention.

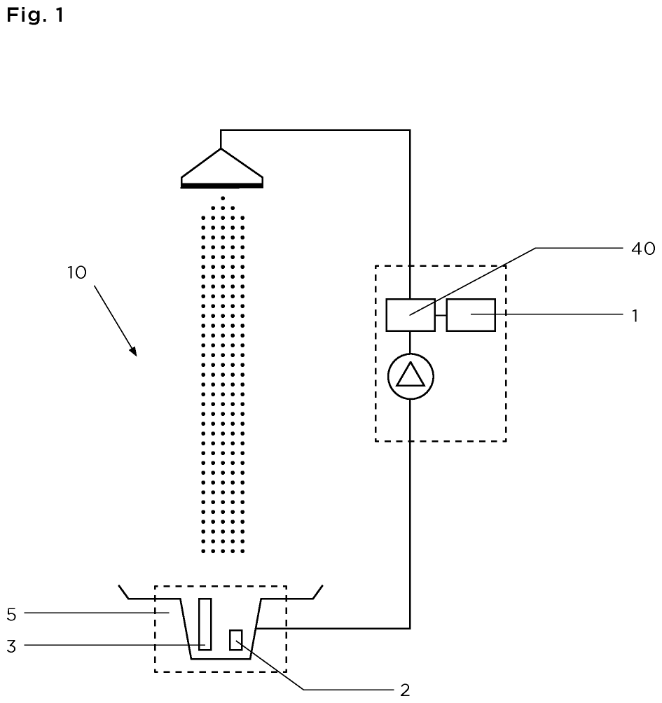

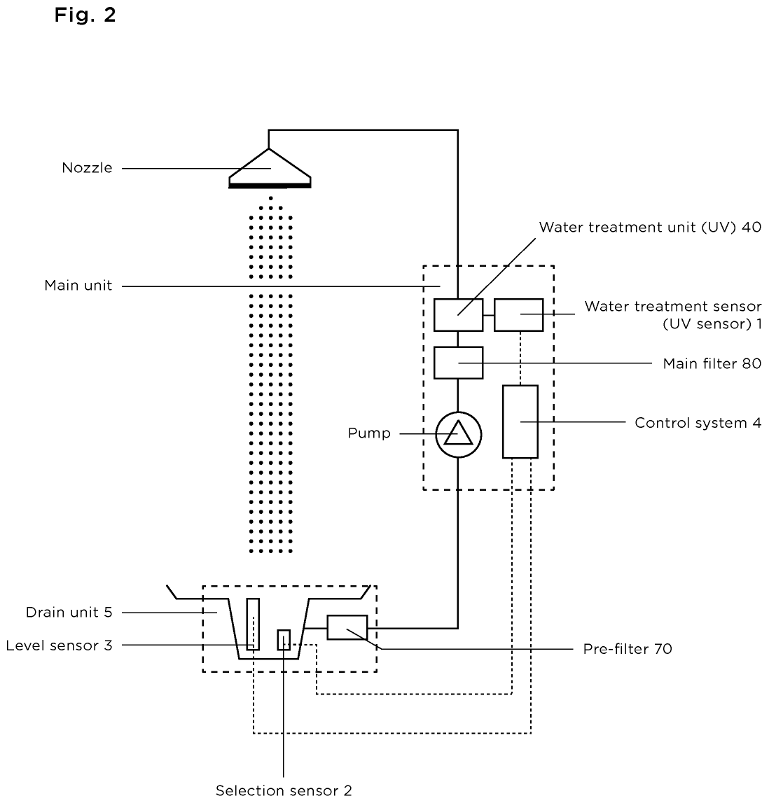

Furthermore, according to yet another specific embodiment of the present invention, the second sensor type is positioned in a drain of the system allowing for purification and recycling of water or separation of water. This is shown in FIGS. 1 and 2. This position provides a second measuring point in the system, which is not the same as the position for the first sensor type.

Moreover, according to yet another embodiment of the present invention, the sensor system also comprises a third sensor type. According to one specific embodiment the third sensor type is a level sensor in a drain of the system allowing for purification and recycling of water or separation of water. Moreover, according to yet another specific embodiment of the present invention, the third sensor type also gives input to the control system with respect to a selection decision of either recycling of water in the system or separation of water from the system. This implies that also this sensor may have the same sort of technical contribution to the learning control system according to the present invention.

The level sensor measures the water level in the floor drain of the system (see the shower example in FIGS. 1 and 2). As this level may vary over time based on the usage profile of e.g. a shower this input or value may also become a parameter which the control system takes into account when making the selection decision. As an example, when someone is showering a long hair, then the flow of water will decrease firstly and then increase vigorously. This flow profile could then indicate that a user is showering the hair, and shampoo or conditioner is thus being flushed into the drain. This is also an input which the control system can take into account when the selection decision is made.

Also this feature of the third sensor is a secondary use of that sensor. The main purpose of such a sensor is otherwise to prevent air from being introduced into the system when the level of water is too low. The same double functionality is valid for a UV sensor as the first sensor type as this sensor first of all controls the UV lamp and glass surrounding the same (or in fact that light reaches the sensor) but also the water quality as a secondary parameter. In both of the cases these sensors complement the second type of sensor regarding providing information to a control system with reference to performing a selection decision in the control system.

Therefore, according to one embodiment of the present invention, the sensor system comprises a first sensor type directed to indicate the function of the water treating source in the water treatment unit, e.g. a UV source, a second sensor type directed to indicate the water quality, and also a third sensor type being a level sensor in a drain of the system allowing for purification and recycling of water or separation of water. As should be understood, this sensor system according to the present invention has the following properties, which properties are also linked to the control system:

it measures the functionality of the water treatment source, such as measures the UV dose in the case of a UV source, which is an indicator of the water treatment effect;

it measures the water quality which in turn may be the key indicator of if water is to be recirculated in the system or separated off (also in real-time); and

it measures the water level in the recirculation tank, which in turn gives input to the flow regulation, e.g. so that air is not introduced in the system.

It should however be noted that the present invention also enables the use of information from the second sensor and/or third sensors above to give a response on the water quality. For instance, a second type sensor may also act as a turbidity sensor, where a certain form of measurement or indication may be directed to dirty or contaminated water, either based on settings in themselves or based on historic data in the control system from that sensor. Moreover, the third sensor type being the level sensor may also show an increase in level etc. which in turn is directed to a certain user pattern, e.g. shampoo or conditioner use, and which as such also indicates a contaminated water, i.e. gives a response on water quality.

As may be understood from above, the second and third sensor types may in fact also be a first sensor type. Moreover, the first and second sensor types may in fact be provided in one and the same sensor, e.g. a UV sensor also acting as a turbidity sensor. Therefore, according to one specific embodiment of the present invention, the first sensor type and the second sensor type are provided in one and the same single sensor. It should be noted that in such a case the system may of course comprise several such sensors or may be combined with other sensors, of any type, also such according to the first, second and third type discussed herein.

Furthermore, the control system may be adapted to learn the behaviour or response behaviour over time for all the sensor types, and may as such function as a learning sensor system.

Moreover, in relation to the above it should be noted that it is of interest to understand the meaning of the word “drain” in the context of the present invention. The word “drain” according to the present invention implies a point leading to the sewage, but in fact is not the sewage in itself. Moreover, the system according to the present invention may also comprise a unit like a recirculation tank positioned adjacent to the drain. The separation point in that case may act as the interface between the recirculation tank and the drain leading to the sewage. Furthermore, in such a case the third sensor type is a level sensor for the recirculation tank.

According to yet another specific embodiment of the present invention there is provided a system allowing for purification and recycling of water or separation of water, said system comprising a sensor system according to the present invention, a water treatment unit and a filter system, which filter system comprises a rough filter unit positioned in a drain of the system and a subsequent mid/fine filter unit.

The rough filter unit may be regarded as a pre-filter (see FIG. 2). The rough filter unit is preferably a removable mesh filter. Furthermore, the mid/fine filter unit may be regarded as a main filter (see FIG. 2). These filters interact to optimise the filtering profile so that the rough filter unit filters off larger particles, e.g. particles above 70 micrometer and hair and other contaminants, while the mid/fine filter unit ensures to absorb finer particles, bacteria, and the like.

Furthermore, as mentioned above, according to one specific embodiment, the system allowing for purification and recycling of water or separation of water comprises a treatment unit which is enclosed in a combined water heater and water treatment unit.

### DETAILED DESCRIPTION OF THE DRAWINGS

In FIG. 1 there is shown a system 10 allowing for purification and recycling of water or separation of water, where said system 10 comprises a sensor system according to one embodiment of the present invention. The system 10 comprises a water treatment unit 40, a drain 5 and a pump. In this case the system 10 is a shower so also a nozzle is provided. The nozzle can of course also be complemented with or replaced by a handheld shower unit. The system 10 comprises a sensor system comprising one first sensor type 1 directed to indicating the function of a water treating source in the water treatment unit 40. The sensor system also comprises a second sensor type 2 directed to indicating the water quality, which in this case is positioned in the drain 5. Furthermore, the drain also holds a third sensor type 3, which in this case is a level sensor.

FIG. 2 shows another shower system 10 allowing for purification and recycling of water or separation of water, said system also comprising a sensor system according to one specific embodiment of the present invention. In this case the system 10 comprises a water treatment unit 40, suitably a combined water heater and water treatment unit, which in this case comprises a UV source, which is connected to a first sensor type 1 (in this case a UV sensor). Moreover, the system 10 also comprises a filter system comprising a main filter 80 being the mid/fine filter and a pre-filter 70 (removable mesh filter). Furthermore, a pump, control system 4, nozzle (and/or handheld shower) and of course piping is also arranged in the system 10. In the drain unit 5, there are provided a second sensor type 2 (main “selection sensor”) and also a third sensor type 3 being a level sensor. Both of these sensors 2, 3 are also connected to the control system 4.

1. A sensor system intended for a system allowing for purification and recycling of water or separation of water, wherein said system allowing for purification and recycling of water or separation of water comprises a water treatment unit, wherein said sensor system comprises one first sensor type directed to indicating the function of a water treating source in the water treatment unit, and wherein the sensor system also comprises a second sensor type directed to indicating the water quality, and wherein both the first sensor type and the second sensor type give input to a control system of the system with respect to a selection decision of either recycling of water in the system or separation of water from the system.

2. The sensor system according to claim 1, wherein the water treating source is a light unit and the first sensor type is a light sensor.

3. The sensor system according to claim 2, wherein the light unit is a UV lamp and the first sensor type is a UV sensor.

4. The sensor system according to claim 1, wherein the first sensor type is a turbidity sensor, IR sensor or FTIR sensor.

5. The sensor system according to claim 1, wherein the second sensor type is a conductivity sensor.

6. The sensor system according to claim 1, wherein the first sensor type and the second sensor type are provided in one and the same single sensor.

7. The sensor system according to claim 1, wherein the second sensor type is positioned in a drain of the system allowing for purification and recycling of water or separation of water comprises a water treatment unit.

8. The sensor system according to claim 1, wherein the sensor system also comprises a third sensor type being a level sensor in a drain of the system allowing for purification and recycling of water or separation of water.

9. The sensor system according to claim 8, wherein also the third sensor type gives input to the control system with respect to a selection decision of either recycling of water in the system or separation of water from the system .

10. A system allowing for purification and recycling of water or separation of water, said system comprising a sensor system according to claim 1, a water treatment unit and a filter system, wherein the filter system comprises a rough filter unit positioned in a drain of the system and a subsequent mid/fine filter unit.

11. The system allowing for purification and recycling of water or separation of water according to claim 10, wherein the treatment unit is enclosed in a combined water heater and water treatment unit.
